(19) United States
(12) Patent Application Publication
(10) Pub. No.: US 2010/0146281 A1
(43) Pub. Date: Jun. 10, 2010

(54) SECURITY AND CERTIFICATE MANAGEMENT FOR ELECTRONIC BUSINESS TO BUSINESS TRANSACTIONS

(75) Inventors: Bruno Grieder, Paris (FR); Jean-Pierre Foehn, Avon (FR); Emmanuel Thiriez, Le Chesnay (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Amalto Technologies Corp., Houston, TX (US)

(21) Appl. No.: 12/632,327

(22) Filed: Dec. 7, 2009

Related U.S. Application Data
(60) Provisional application No. 61/120,231, filed on Dec. 5, 2008.

(51) Int. Cl. H04L 9/32

(52) U.S. Cl. 713/175

(57) ABSTRACT

Methods, systems, and devices are described for the secure electronic exchange of procurement documents. A server computer system may manage different sets of security procedures, distributing certificates to trading partners. These certificates may be community-specific certificates for a limited community of trading partners. When particular trading partners (e.g., of the community) agree to exchange procurement documents, they may first exchange their certificates (or portions thereof) with each other. A sending trading partner may then provide an electronic signature for a procurement document to be transmitted, and encrypt the signed procurement document using the receiving trading partner's public key.

### CROSS-REFERENCES TO RELATED APPLICATIONS

This Application claims priority from co-pending U.S. Provisional Patent Application No. 61/120,231, filed Dec. 5, 2008, entitled “SECURITY AND CERTIFICATE MANAGEMENT FOR ELECTRONIC BUSINESS TO BUSINESS TRANSACTIONS”, which is hereby incorporated by reference, as if set forth in full in this document, for all purposes.

This Application is related to the following U.S. Patent Applications, the entire disclosures of which are hereby incorporated by reference for all purposes: U.S. application Ser. No. 12/328,935, filed on Dec. 5, 2008, by Grieder et al., entitled “COMMUNITY MANAGEMENT FOR ELECTRONIC BUSINESS TO BUSINESS TRANSACTIONS”; and U.S. application Ser. No. ______ (Attorney Docket Number 027748-000310US), filed concurrently herewith by Grieder, et al., entitled “DISTRIBUTED DOCUMENT TRANSFORMATION FOR ELECTRONIC BUSINESS TO BUSINESS TRANSACTIONS”.

### BACKGROUND

The present invention is generally related to business to business (B2B) document exchange and, more specifically, to the automated and/or secure exchange of electronic business documents.

Traditionally, the automated exchange of electronic procurement documents has been limited to large corporations. Complex, centralized software products and related support are used to handle transformations and connect the corporation with each of its trading partners. This may involve difficult network and firewall settings, and complex protocols.

By way of example, some of these behind the firewall solutions involve 1) choosing and purchasing a software solution, 2) selecting an integrator for setting up the solution, 3) investing in internal competencies training for maintenance and monitoring purposes (or contracting someone to do so), and 4) going through a new project for each new trading partner or business document flow to be implemented.

Some of these implementation issues have been addressed using various SaaS (Software as a Service) solutions, but there are a number of challenges that remain related to the centralized nature of such document exchanges, and the limited flexibility of such a model. However, as more flexible, de-centralized options are considered, security concerns may arise. Therefore, there may be a need in the art for a flexible, secure solution for procurement document exchange between approved trading partners.

### SUMMARY

Methods, systems, and devices are described for the secure electronic exchange of procurement documents. In one set of embodiments, a server computer system may manage different sets of security procedures for each of a number of sets of trading partners. Once a trading partner has registered, one or more certificates may be distributed by a server computer system to the registered trading partner. These certificates may be community-specific certificates for use in a limited community of trading partners.

When particular trading partners (e.g., of a community) agree to exchange procurement documents, they may first exchange their certificates (or portions thereof) with each other. A sending trading partner may then provide an electronic signature for a procurement document to be transmitted, and encrypt the signed procurement document using the receiving trading partner's public key. The procurement document may be transmitted directly between trading partners, or through a relay server. The receiving trading partner may then verify the electronic signature for the transmitted procurement document, and decrypt the procurement document using his private key.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system for secure document exchange configured according to various embodiments of the invention.

FIG. 2 is a block diagram of a system for secure document exchange between trading partners according to various embodiments of the invention.

FIG. 3 is a block diagram of a server computer system for managing secure document exchange according to various embodiments of the invention.

FIG. 4 is a block diagram of a computing device for a trading partner for secure document exchange according to various embodiments of the invention.

FIG. 5 is a flow chart of a method for managing secure document exchange according to various embodiments of the invention.

FIG. 6 is a flow chart of a method for managing secure document exchange between trading partners according to various embodiments of the invention.

FIG. 7 is a flow chart of a method for securely transmitting a document according to various embodiments of the invention.

FIG. 8 is a flow chart of a method for securely receiving a document according to various embodiments of the invention.

### DETAILED DESCRIPTION

Methods, systems, and devices are described for the secure electronic exchange of procurement documents. A server computer system may manage different sets of security procedures, distributing certificates to trading partners. When particular trading partners (e.g., of a particular community of trading partners) agree to exchange procurement documents, they may first exchange their certificates (or portions thereof) with each other. A sending trading partner may then provide an electronic signature for a procurement document to be transmitted, and encrypt the signed procurement document using the receiving trading partner's public key. The receiving trading partner may then verify the electronic signature for the transmitted procurement document, and decrypt the procurement document using his private key.

This description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

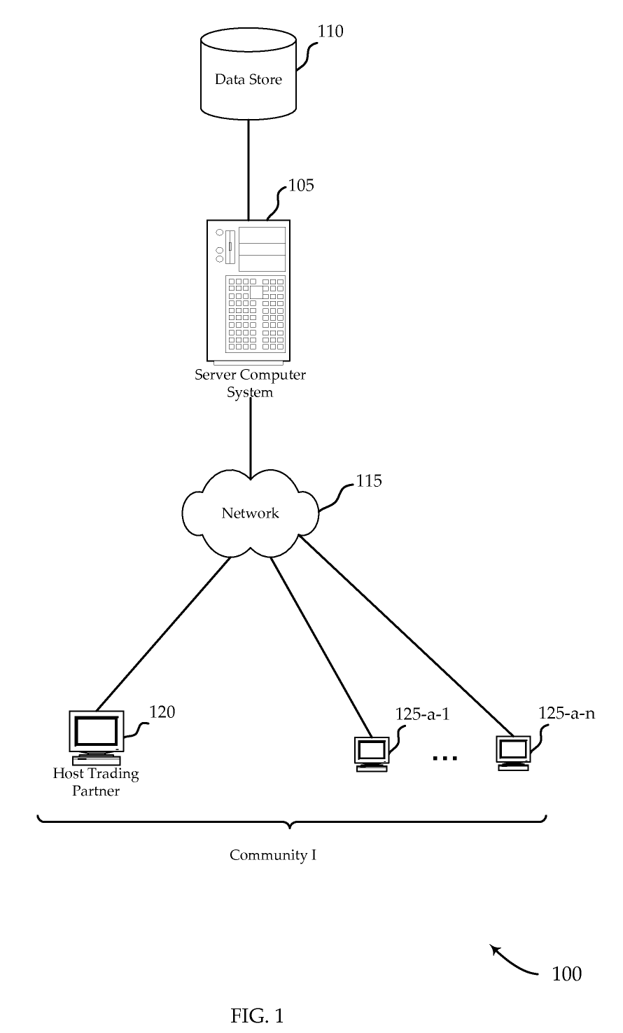

Systems, devices, methods, and software are described for the automated, secure exchange of electronic procurement documents. In one set of embodiments, shown in FIG. 1, the system 100 includes a server computer system 105. The server computer system 105 may be in communication with a data store 110, one (or more) host trading partners 120, and one (or more) communities of trading partners 125-a. The host trading partners 120 and peer trading partners 125 may each communicate with the server computer system 105 via respective computing devices. The components of the system 100 may be directly connected, or may be connected via a network 115. In the following example, a single host trading partner 120 may create rules for a community of trading partners 125, but note that in other embodiments there need not be communities.

The server computer system 105 may include, for example, one or more server computers, workstations, web servers, or other suitable computing devices. The server computer system 105 may be fully located within a single facility or distributed geographically, in which case a network 115 may be used to integrate different components. The server computer system 105 may be configured to communicate with the data store 110. The server computer system 105 may manage different sets of rules for each of a number of communities of trading partners 125, or for other groups or sub-groups of trading partners 125. For each set of rules (e.g., for each community), rules may be included for the secure exchange of procurement documents (e.g., within the community), and may specify trading partners invited to join. These sets of rules may be stored in the data store 110 by the server computer system 105, and then manipulated or accessed therein by the server computer system 105. As trading partners 125 register, all or part of the set of rules may be distributed by the server computer system 105 to the registered trading partners 125.

The data store 110 may be a single database, while in other embodiments, it may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may be multiple data storages (of the same or different type), or may share a common data storage with other data stores. Although in some embodiments the data store 110 may be distinct from a server computer system 105, in other embodiments it may be integrated therein to varying degrees.

A host trading partner 120 may select a set of rules (e.g., for a community or set of communities of trading partners). A single host trading partner 120 may create different communities, and subsequently modify the rules therein; for other communities, multiple host trading partners 120 may have the joint ability to create or modify rules for the community. Regardless of the particular configuration, a host trading partner 120 may transmit selection data to the server computer system 105, the selection data identifying rules for exchange of procurement documents between trading partners 125-a (and/or between trading partners 125-a and a host trading partner 120). The selection data may specify the subscription process, the visibility rules, the certificate generation and exchange process, the allowed document types, the transformation rules, and the trading partners invited to join the community, and may include community-specific plug-ins. The host trading partner 120 may be a trading partner 125 in a community, or not.

As noted above, the server computer system 105 may receive the selection data, and generate rules based on the selection data. These generated rules may be stored as rules data in the data store 110 by the server computer system 105. The server computer system 105 may generate and transmit advertisements to those trading partners 125 who are invited to join a particular group or community of trading partners.

The server computer system 105 may register trading partners 125 responding to the advertisements, and this registration may be community-specific. For example, the registration may occur with the subscription form and related process (e.g., automated, requiring a validation, or requiring a payment) specified in the rules data for a community. The registered trading partners 125 for each community may be stored in the data store 110 by the server computer system 105. Based on visibility rules for each community, the server computer system 105 may identify and distribute address information for each of the registered trading partners 125 to the remaining trading partners 125 of the applicable community. For example, in some communities, all trading partners 125 may be visible to each other, while in others, they are each visible only to the host trading partner 120.

Once a trading partner 125 is registered, the server computer system 105 may distribute all or part of the rules data to the trading partner 125 (e.g., this distribution may be community-specific). The distributed rules data may include a plug-in module (e.g., with various user interface, security, or transformation capabilities), include a certificate (e.g., a community-specific certificate generated for a particular trading partner), include a set of certificate exchange rules, specify the allowed documents that may be used, specify other transformation rules or specifications for the community, and identify validation rules, as well.

In one set of embodiments, the registered trading partners 125 of the community may then exchange procurement documents directly (peer to peer), according to the distributed rules. When particular trading partners (e.g., of a community) agree to exchange procurement documents, they may first exchange their certificates (or portions thereof) with each other. A sending trading partner may then provide an electronic signature for a procurement document to be transmitted, and encrypt the signed procurement document using the receiving trading partner's public key (e.g., received via the certificate exchange with the receiving trading partner). The receiving trading partner may then verify the electronic signature for the transmitted procurement document (e.g., known via the certificate exchange), and decrypt the procurement document using the receiving trading partner's private key.

In another set of embodiments, a server computer system 105 manages different sets of transformation rules and plug-ins for various sets of trading partners. Procurement document transformation rules, allowed document type rules, and plug-ins may be distributed by a server computer system to a trading partner (e.g., with the rest of the rules data, or separately). These may be community-specific rules and plug-ins for a particular community of trading partners. A sending trading partner may then generate a procurement document to be transmitted according to the allowed document type rules. Using the downloaded plug-in, the sending trading partner may locally transform the procurement document for transmission to the receiving trading partner. The receiving trading partner may receive the transformed procurement document, and locally transform the procurement document using the distributed plug-in.

In some communities, the procurement document exchange may occur only between a host trading partner 120 and other trading partners 125 of the community; in other communities, the document exchange may occur between peers, as well. There may be any number of hybrid systems, as well, wherein document exchange may occur between only a subset of the peers. This document exchange, within a community, may be only available between the members of the community, and not open to the public. Moreover, while in some embodiments the document exchange may be performed directly peer to peer, and not conducted through the server computer system 105, in other embodiments, the exchange may occur via a relay server in the server computer system 105.

The components of the system 100 may be directly connected, or may be connected via a network 115, which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network 115 may include both wired and wireless connections, including optical links. Many other examples are possible and apparent to those skilled in the art in light of this disclosure. In the discussion herein, a network 115 may or may not be noted specifically. If no specific means of connection is noted, it may be assumed that the link, communication, or other connection between devices may be via a network 115.

As the term is used herein, “procurement documents” may include a request for information, a request for price, a request for quotation, a quote, a purchase order, a sales order, a change order, an order cancellation, an order confirmation response, an order response, an order status request, an order status response, an advance shipment notification, a dispatch advice, a goods receipt, a receipt advice, a planning schedule, a shipping schedule, a supply schedule, a supply schedule response, a delivery planning, a delivery planning response, a delivery planning proposal, an invoice, an invoice response, a freight invoice, a self billed credit note, a self billed invoice, a credit note, a debit note, a remittance advice, a payment request, a payment status request, a payment status response, an inventory report, a consumption forecast, a consumption report, a bill of lading, a transportation status, a waybill, forwarding instructions, a catalog, a catalog deletion, a catalog item specification update, a catalog pricing update, or catalog request.

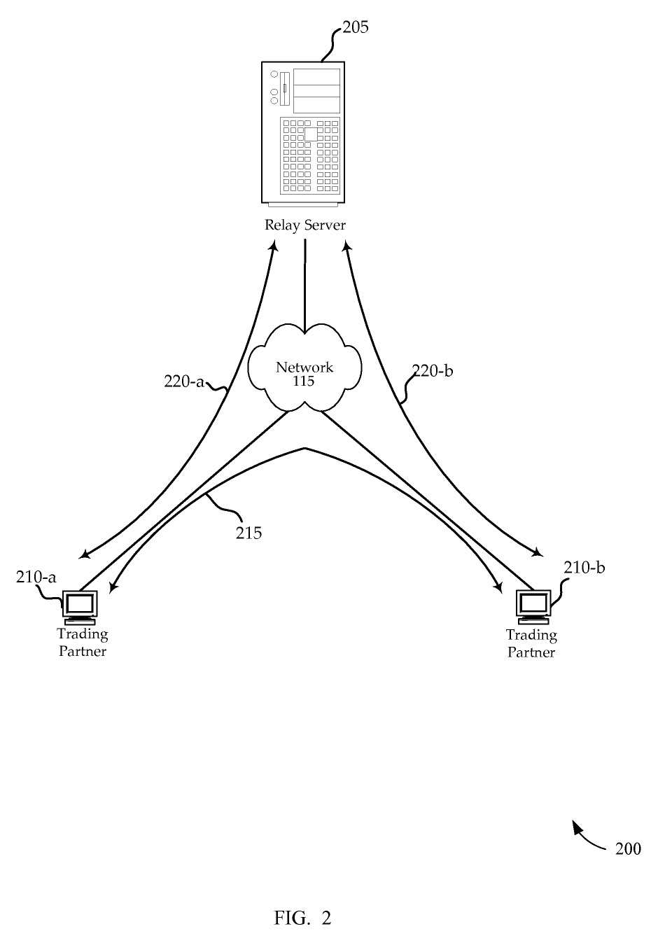

Turning to FIG. 2, a block diagram 200 illustrates an example exchange of procurement documents between a first trading partner 210-a and a second trading partner 210-b. These trading partners may be two of the trading partners 125 of FIG. 1. This exchange of procurement documents may be a direct exchange 215, through a network 115. Alternatively, it may be an indirect exchange 220 through a relay server 205 (which may, but need not, be the server computer system 105 for FIG. 1). The following description with reference to FIG. 2 provides an example wherein the distributed transformation architecture is integrated with certain certificate exchange mechanisms; however, it is worth noting that in other embodiments either aspect, or portions thereof, may be performed independently.

Assume that each trading partner 210 has downloaded or otherwise received all or part of a set of rules for the exchange of procurement documents. These rules may, but need not, be community-specific rules. These distributed rules may include a plug-in module (e.g., with various user interface, security, or transformation capabilities), include a certificate (e.g., a community-specific certificate generated for the particular trading partner 210-a or 210-b of the community), include a set of certificate exchange rules and procedures, specify the allowed documents that may be used, and specify other transformation rules or specifications for the community. These distributed rules may be the rules data distributed by the server computer system 105 of FIG. 1.

There may, but need not, be different types of certificates. For example, when a trading partner 210 has registered in the system (e.g., system 100 of FIG. 1), one or more registration certificates may be distributed by a server computer system 105 to the registered trading partner 210. When a trading partner 210 wants to register to a specific community or group, it may generate a private key, and create a certificate signing request (CSR) using the private key. The trading partner 210 may then fill out a subscription form for the particular community group, and sign and encrypt the CSR and form (using the registration certificate) for transmission to the server computer system 105 for FIG. 1. If the completed subscription form is valid and approved, a community-specific or other group-specific certificate may be distributed. Thus, the distributed certificate may be a function of the private key (e.g., because the CSR is a function of the private key, and the certificate (including a public key) is a function of the CSR).

It is worth noting that such community- or group-specific certificates may be used for a limited set of trading partners 210. When particular trading partners 210 (e.g., of a community) agree to exchange procurement documents, they may first exchange their certificates (or portions thereof) with each other (e.g., trading partner 210-a and trading partner 210-b may swap all or part of their community-specific certificates). This certificate exchange may be via a direct connection 215 (or through the relay server 205 or a server computer system 105 of FIG. 1).

In the following example for FIG. 2, assume that a first procurement document exchange certificate is generated for a sending trading partner 210-a, and a second procurement document exchange certificate is generated for receiving trading partner 210-b. Further, assume that sending trading partner 210-a transmits a portion of a first procurement document exchange certificate to receiving trading partner 210-b. Also, assume that receiving trading partner 210-b transmits a portion of a second procurement document exchange certificate (including a public key) to sending trading partner 210-a.

The sending trading partner 210-a may then wish to exchange a particular procurement document with the receiving trading partner 210-b. The sending trading partner 210-a may then attempt to open a direct connection to receiving trading partner 210-b. For the immediately following discussion, it will be assumed that the direct connection is successfully opened. The case where the connection is unsuccessful (directed toward use of the relay server 205) will be addressed later.

The sending trading partner 210-a may then generate a procurement document to be transmitted according to the allowed document type rules. For example, the rules may specify that only 1) Excel documents, 2) Excel documents and PDF attachments, or 3) Petroleum Industry Data Exchange (PIDX) documents be used. In other embodiments, different types or combinations of documents may be allowed. Using the downloaded plug-in, the sending trading partner 210-a may locally transform the procurement document for transmission to the receiving trading partner 210-b. For example, the rules may specify that Excel documents, and Excel documents with PDF attachments, will be transformed into PIDX documents for transmission. Thus, in this example, a PIDX procurement document is to be transmitted, regardless of which type of document was originally generated.

A sending trading partner 210-a may then provide an electronic signature for the PIDX procurement document to be transmitted (e.g., using the first procurement document exchange certificate). The sending trading partner 210-a may encrypt the signed PIDX procurement document using the receiving trading partner's 210-b public key (which was received through the certificate exchange between the sending trading partner 210-a and receiving trading partner 210-b). The procurement document may be transmitted directly on path 215 (via a direct connection between the sending trading partner 210-a computing device and the receiving trading partner 210-b computing device, avoiding the relay server 205).

The receiving trading partner 210-b may receive the encrypted PIDX document (encrypted by the sending trading partner 210-a using the public key of the receiving trading partner 210-b). The receiving trading partner 210-b may then decrypt the procurement document using his private key. The receiving trading partner 210-b may verify the signature of the sending trading partner 210-a (e.g., using information from the first procurement document exchange certificate gained through the certificate exchange between the sending trading partner 210-a and receiving trading partner 210-b). If the signature is verified, the receiving trading partner 210-b may locally transform the PIDX procurement document using the distributed plug-in. The plug-in at the receiving trading partner 210-b may be locally configurable to allow the receiving trading partner 210-b to specify the delivered format. For example, the receiving trading partner 210-b may specify that he would only like to receive Excel documents, and the plug-in would transform the received PIDX procurement document into Excel document form. A double acknowledgement may be performed at the end of the process.

As noted, there may be rules specifying the allowed document types to be input and transmitted for a community. The specific document types are examples only, as a document type may be one or more types of extensible markup language (XML) documents, Petroleum Industry Data Exchange (PIDX) documents (e.g., PIDX-RNIF or PDIX AS2), Chemical Industry Data Exchange (CIDX) documents, commerce eXtensible Markup Language (cXML) documents, XML Common Business Library (xCBL) documents, Universal Business Language (UBL) documents, Electronic Business using eXtensible Markup Language (ebXML) documents, XML Book Industry Transmission Standards (XBITS) documents, Excel or other spreadsheet documents, portable document format (PDF) documents, any combination, and any other formatted document types. In one embodiment, community-specific document transformation rules may identify standardized document formats for direct exchange of procurement documents between trading partners of the community. In other embodiments, the allowed document specification may specify the document format that may be used before transformation, after transformation, or before, during, or after transmission. Thus, the generated rules data may specify the types of allowed documents that may be input into a downloaded plug-in for transformation, the types that may be transmitted, or the types that may be received.

The above description assumes that a direct connection 215 is opened between the sending trading partner 210-a and receiving trading partner 210-b. To do so, a sending trading partner 210-a may issue a signed connection request to the receiving trading partner 210-b. The receiving trading partner 210-b may verify the signature for the connection request, open a socket, and return a socket address to the sending trading partner 210-a (including physical connectivity details). The direct connection 215 may then be established. If the direct connection 215 is unable to be established, a relay server 205 may be used. The sending trading partner 210-a may sign and encrypt a transformed procurement document, and transmit 220-a the document to a relay server 205. The receiving trading partner 210-b may synchronously or later pull 220-b the procurement document from the relay server 205. Upon receipt of the pulled procurement document, the receiving trading partner 210-b may process the document in a similar manner to the processing of the direct connection.

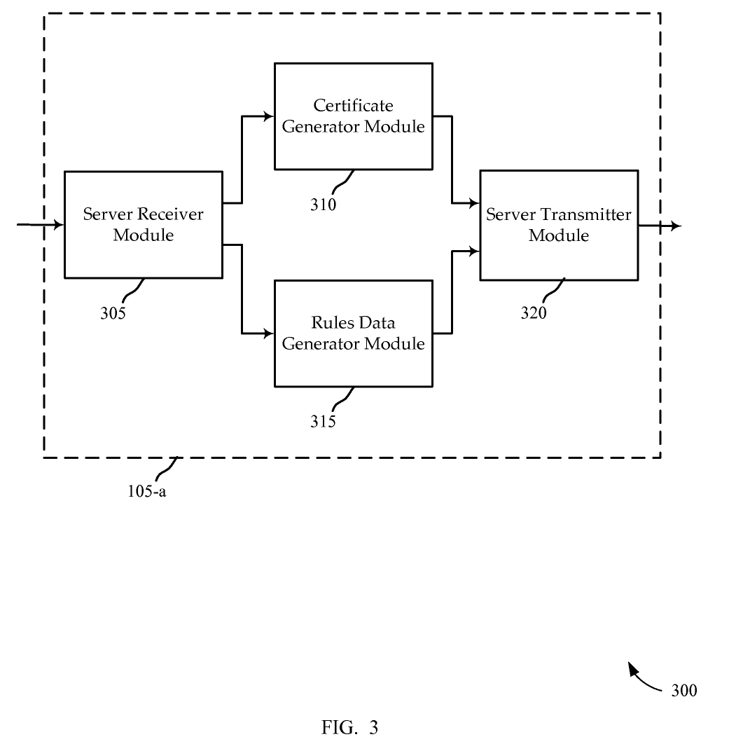

Turning next to FIG. 3, a block diagram is shown illustrating an example configuration 300 for a server computer system 105-a configured to distribute certificates. This configuration 300 may be the server computer system 105 described with reference to FIG. 1. However, some or all of the functionality of these modules may be implemented in other devices or sets of devices.

The configuration 300 includes a server receiver module 305, a certificate generator module 310, a rules data generator module 315, and a server transmitter module 320, which may each be in communication with each other. These modules may, individually or collectively, be implemented, in whole or in part, with instructions embodied in a memory, formatted to be executed by one or more general or application-specific processors. They may also be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

A server computer system 105-a may receive selections for a community (e.g., from the host trading partner 120 of FIG. 1) via the server receiver module 305. The rules data generator module 315 may generate community-specific rules data for distribution to computing devices operated by trading partners of the particular community (e.g., the trading partners 125 of FIG. 1). The rules data may include a plug-in module (e.g., with various user interface, security, or transformation capabilities), include a set of certificate exchange rules, specify the allowed documents that may be used, specify other transformation rules or specifications for the community, and identify validation rules, as well. The server transmitter module 320 may transmit the rules to each respective computing device of the community after the registration of the respective trading partners.

Assume that registration of a trading partner (e.g., trading partner 125 of FIG. 1) has been received through the server receiver module 305, and has been approved. The certificate generator module 310 may generate a community-specific procurement document exchange certificate for a computing device operated by the trading partner. The certificate may be based on a certificate signing request (CSR) transmitted from the computing device, and received via the server receiver module 305. The CSR may be created locally at each respective computing device from a private key generated locally at each computing device. The procurement document exchange certificate may include a public key. The server transmitter module 320 may transmit the generated procurement document exchange certificate to the computing device. The computing device may then distribute a portion of the certificate to other trading partners within the community which will allow such trading partners to decrypt and verify the signature on signed and encrypted procurement documents transmitted from the computing device. The certificate generator module 310 may generate other certificates for other trading partners of the community using similar processes.

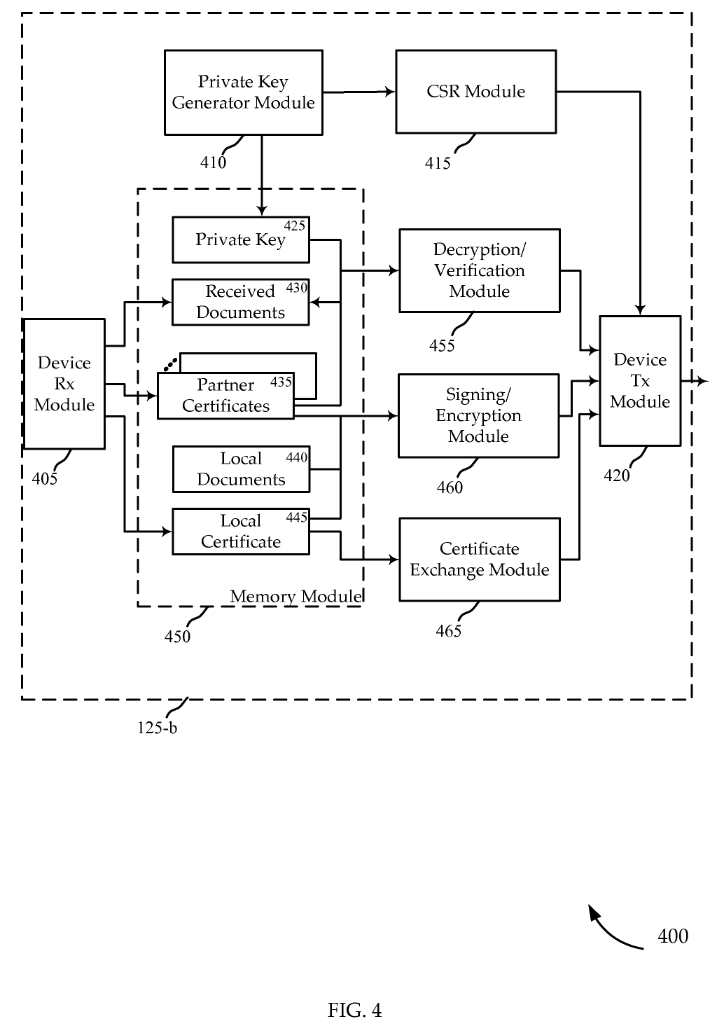

Turning next to FIG. 4, a block diagram is shown illustrating an example configuration 400 for a computing device for a trading partner 125-b configured to exchange certificates to establish secure procurement document exchange. This configuration 400 may be used for the trading partners 125 described with reference to FIG. 1. However, some or all of the functionality of these modules may be implemented in other devices or sets of devices.

The configuration 400 includes a device receiver module 405, a private key generator module 410, a CSR module 415, a device transmitter module 420, a memory module 450, a decryption/verification module 455, a signing/encryption module 460, and a certificate exchange module 465. The memory module 450 stores data on a per-community basis (although in other embodiments, there need not be communities). As will be discussed below, the memory module 450 includes storage for a private key 425, for received procurement documents 430, for partner certificates 435, for local documents 440, and for the local certificate 445. Each module may be in communication with each other. These modules may, individually or collectively, be implemented, in whole or in part, with instructions embodied in a memory, formatted to be executed by one or more general or application-specific processors. They may also be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

In one set of embodiments, private key generator module 410 generates a private key for the device 125-b (which may, for example, be 1024 or 2048 bits long in certain embodiments). The private key may be different for different communities. The private key may be stored in private key memory 425, and forwarded to the CSR module 415. The CSR module 415 may generate a certificate signing request (CSR) using the private key. The device transmitter module 420 may transmit the CSR and a subscription form for the community to a subscription server (e.g., the server computer system 105 of FIG. 1 or 3).

Using the CSR, the subscription server may generate a community-specific certificate (which, for ease in explanation, may be referred to as the “local certificate”) for trading partner 125-b, and transmit the local certificate back to the trading partner 125-b. The certificate may include a public key (which, for ease in explanation, may be referred to as the “local public key”). The local certificate is received at device receiver module 405, and stored at local certificate memory 445. When particular trading partners of a community agree to exchange procurement documents, there first is an exchange of certificates (or portions thereof) with each other. Thus, the certificate exchange module 465 may extract a portion of the certificate from local certificate memory 445 for transmission by device transmitter module 420 to a computing device of a selected trading partner. This local certificate may be used by the selected trading partner to verify a signature of a later transmitted procurement document from the computing device of trading partner 125-b. The certificate may also include the local public key for use by the selected trading partner to encrypt procurement documents for transmission back to the computing device of trading partner 125-b. The selected trading partner may transmit a certificate (which, for ease in explanation, may be referred to as the “partner certificate”) to be used by the computing device of trading partner 125-b to verify a signature of a later transmitted procurement document from the selected trading partner 125-b. The partner certificate from the selected trading partner may also include a public key (which, for ease in explanation, may be referred to as the “partner public key”) for use by the computing device of trading partner 125-b to encrypt procurement documents for transmission to the selected trading partner. The partner certificate from the selected trading partner may be received at device receiver module 405, and stored in partner certificates memory 435. The certificate exchange process may be repeated for other trading partners. This certificate exchange may be via a direct connection (or be through the relay server 205 of FIG. 2 or a server computer system 105 of FIG. 1).

When trading partner 125-b wants to transmit a procurement document to the selected trading partner, there may be an input to trigger a transmission of the procurement document to the computing device of the selected trading partner (e.g., identifying a particular procurement document to be transmitted from local document memory 440). In response to the input, the signing/encryption module 460 may automatically sign (e.g., without any additional user input) the identified procurement document. The signing/encryption module 460 may access the procurement document from local document memory 440, and sign the accessed document using information from the local certificate stored in local certificate memory 445. The signing/encryption module 460 may then automatically encrypt (e.g., without any additional user input) the signed document using the partner public key stored in partner certificates memory 435. The signed and encrypted procurement document may then be transmitted by device transmitter module 420 to a computing device of a selected trading partner. The selected trading partner may decrypt the document using the partner private key (e.g., locally generated at the selected trading partner, and used (directly or indirectly) to create the partner public key). The selected trading partner may verify the signature using the portion of the local certificate previously provided to the selected trading partner by trading partner 125-b.

When trading partner 125-b is to receive a procurement document from the selected trading partner, the reverse process may be used. The trading partner may receive a signed and encrypted procurement document from the selected trading partner via the device receiver module 405, and stored in received documents memory 430. The signed and encrypted procurement document may be encrypted by the computing device of the selected trading partner using the local public key transmitted to the selected trading partner. The decryption/verification module 455 may automatically decrypt (e.g., without any user input to perform the decryption step once the document at issue is received) the signed and encrypted procurement document using the private key from private key memory 425. The decryption/verification module 455 may automatically verify (e.g., without any user input to perform the verification step once the document at issue is received) the signature of the decrypted procurement document using the received portion of the partner certificate. Once verified, the procurement document may be again stored in received documents memory 430.

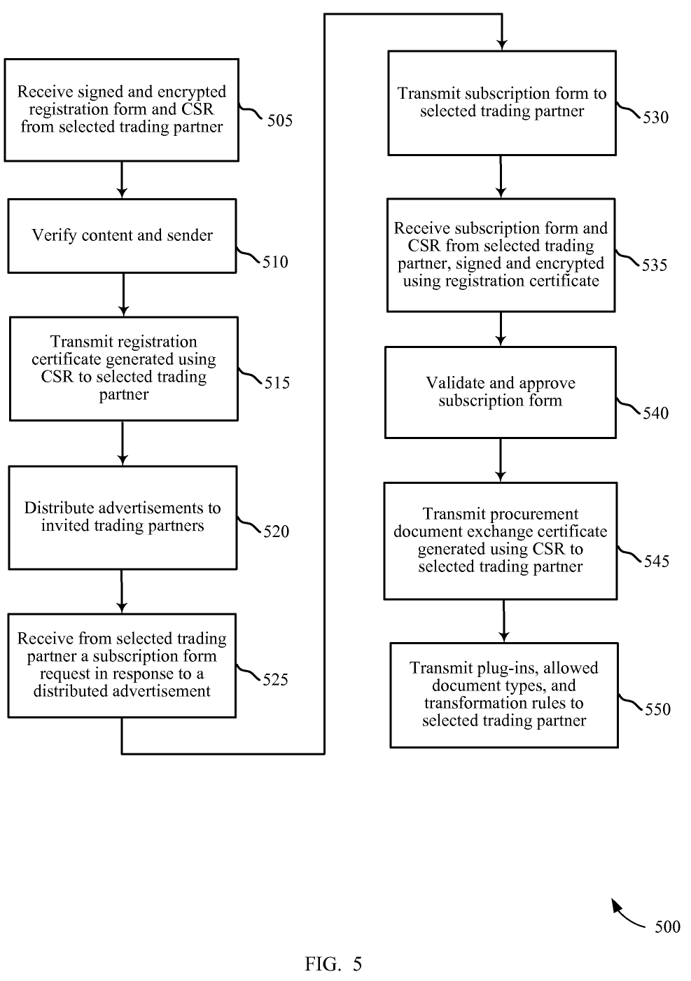

Referring next to FIG. 5, a flow chart is shown illustrating a method 500 for certificate distribution to provide for secure procurement document exchange according to various embodiments of the invention. This method 500 may, for example, be performed in whole or in part by the server computer system 105 of FIG. 1 or 3. In other embodiments, some or all of these steps may be performed by a host trading partner 120 or other trading partner 125 of FIG. 1 or 4, a trading partner 210 or relay server 205 of FIG. 2, or any combination thereof.

At block 505, a signed and encrypted registration form and certificate signing request are received from a selected trading partner. At block 510, the content and sender are verified. At block 515, a registration certificate generated using the certificate signing request is transmitted to the trading partner. At block 520, advertisements are distributed to invited trading partners (e.g., for a particular group or community of trading partners). At block 525, a subscription form request is received from the selected trading partner in response to the distributed advertisements.

At block 530, the subscription form is transmitted to the selected trading partner. At block 535, the completed subscription form and second certificate signing request are received from the selected trading partner, signed and encrypted using a registration certificate. At block 540, the subscription form is decrypted, validated, and approved. At block 545, a procurement document exchange certificate generated using the second certificate signing request is transmitted to the selected trading partner. This procurement document exchange certificate may be a community-specific certificate to be used for document exchange within a particular community only. At block 550, plug-ins, allowed document types, and transformation rules are transmitted to the selected trading partner.

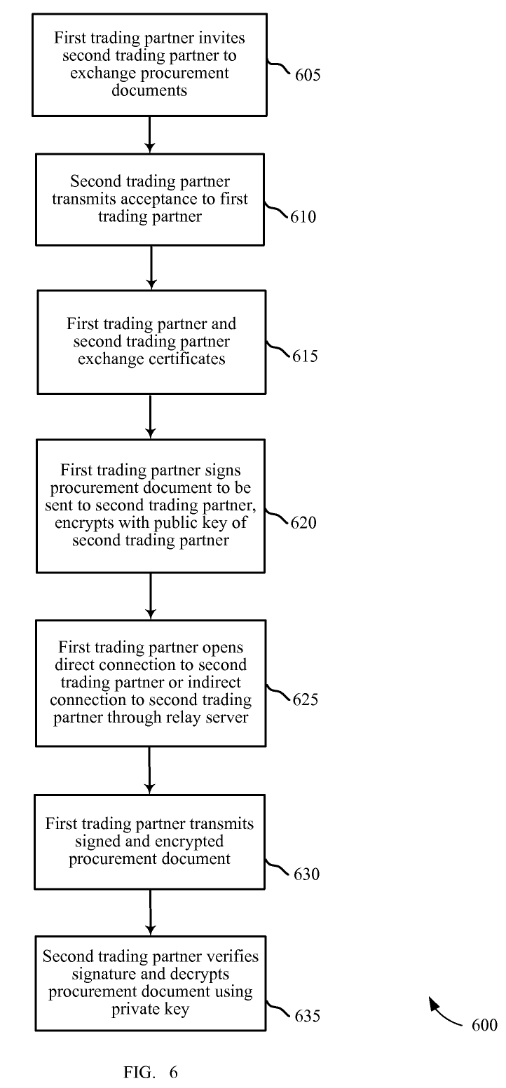

Referring next to FIG. 6, a flow chart is shown illustrating a method 600 for certificate and procurement document exchange between trading partners according to various embodiments of the invention. This method 600 may, for example, be performed in whole or in part by the trading partners 120, 125 of FIG. 1 or 4, or the trading partners 210 of FIG. 2. In other embodiments, one or more of these steps may be performed by the server computer system 105 of FIG. 1 or 3 or relay server 205 of FIG. 2, or any combination thereof.

At block 605, a first trading partner invites a second trading partner to exchange procurement documents. The first and second trading partners may each have received a community-specific procurement document exchange certificate, and also received plug-ins, allowed document type rules, and transformation rules (e.g., according to blocks 545 and 550 of FIG. 5). At block 610, the second trading partner transmits the acceptance to the first trading partner. At block 615, the first trading partner and the second trading partner exchange certificates.

At block 620, the first trading partner signs the procurement document to be sent to the second trading partner, encrypted with the public key of the second trading partner (e.g., received through the certificate exchange). At block 625, the first trading partner opens a direct connection to the second trading partner, or establishes an indirect connection to the second trading partner through a relay server. At block 630, the first trading partner transmits the signed and encrypted procurement document. At block 635, the second trading partner verifies the signature (e.g., via the certificate received through the certificate exchange) and decrypts the procurement document using his private key.

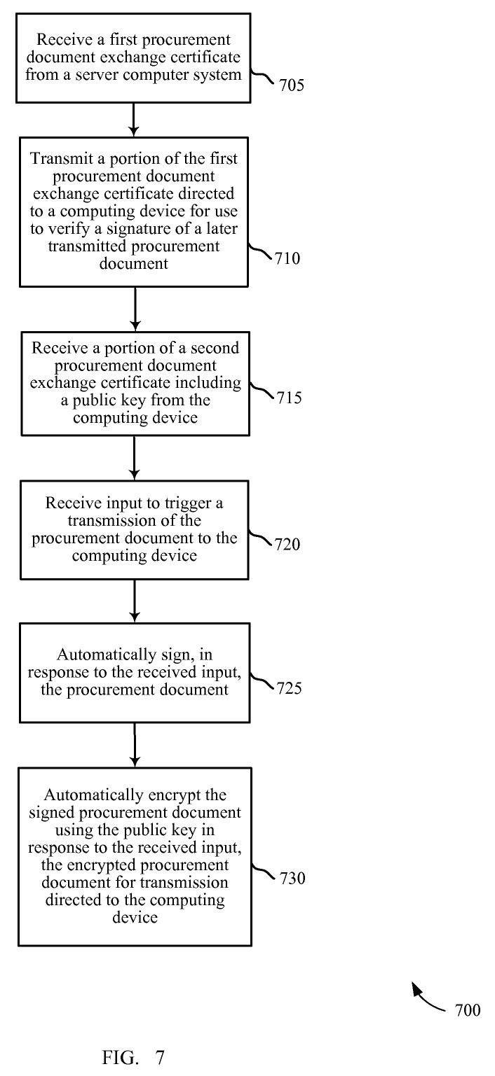

Referring next to FIG. 7, a flow chart is shown illustrating a method 700 for certificate and procurement document exchange between trading partners according to various embodiments of the invention. This method 700 may, for example, be performed in whole or in part by a trading partner 120, 125 of FIG. 1 or 4, or a trading partner 210 of FIG. 2. In other embodiments, some of these steps may be performed by the server computer system 105 of FIG. 1 or 3 or relay server 205 of FIG. 2, or any combination thereof. The method 700 may be implemented using a computer program, stored on a computer readable storage medium, with instructions executable by a computing device (operated, for example, by a trading partner).

At block 705, a first procurement document exchange certificate is received from a server computer system. At block 710, a portion of the first procurement document exchange certificate is transmitted directed to a computing device for use by a computing device to verify a signature of a later transmitted procurement document. At block 715, a portion of a second procurement document exchange certificate is received, the second procurement document exchange certificate including a public key from the computing device.

At block 720, an input is received to trigger a transmission of the procurement document to the computing device. At block 725, the procurement document is automatically signed in response to the received input. At block 730, the signed procurement document is automatically encrypted using the public key in response to the received input, the procurement document encrypted for transmission directed to the computing device.

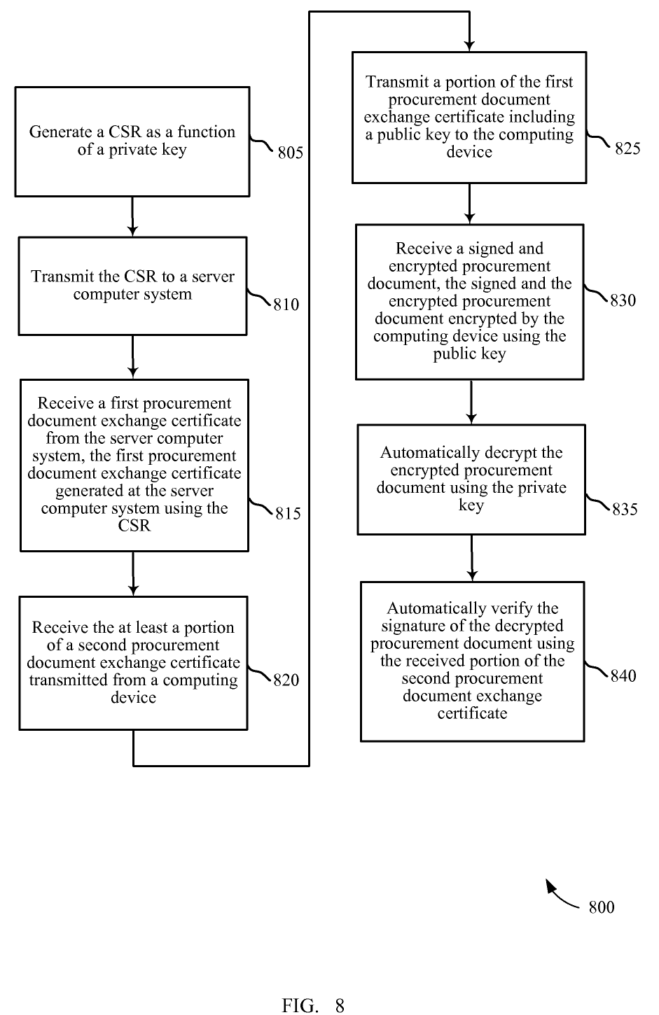

Referring next to FIG. 8, a flow chart is shown illustrating a method 800 for certificate and procurement document exchange between trading partners according to various embodiments of the invention. This method 800 may, for example, be performed in whole or in part by a trading partner 120, 125 of FIG. 1 or 4, or a trading partner 210 of FIG. 2. In other embodiments, some of these steps may be performed by the server computer system 105 of FIG. 1 or 3 or relay server 205 of FIG. 2, or any combination thereof. The method 700 may be implemented using a computer program, stored on a computer readable storage medium, with instructions executable by a computing device (operated, for example, by a trading partner).

At block 805, a certificate signing request is generated as a function of a private key. At block 810, the certificate signing request is transmitted to a server computer system. At block 815, a first procurement document exchange certificate is received from the server computer system, the first procurement document exchange certificate generated at the server computer system using data from the certificate signing request. At block 820, at least a portion of a second procurement document exchange certificate transmitted from a computing device is received.

At block 825, a portion of the first procurement document exchange certificate including a public key is transmitted to the computing device. At block 830, a signed and encrypted procurement document is received, the signed and the encrypted procurement document encrypted by the computing device using the public key. At block 835, the encrypted procurement document is automatically decrypted using the private key. At block 840, the signature of the decrypted procurement document is automatically verified using the received portion of the second procurement document exchange certificate.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory,” “memory module,” or “data store” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, a sim card, other smart cards, and various other storage mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for an exchange of procurement documents, the system comprising:
a server computer system configured to:
generate a first procurement document exchange certificate for a first computing device;
generate a second procurement document exchange certificate for a second computing device; and
transmit the first procurement document exchange certificate to the first computing device and the second procurement document exchange certificate to the second computing device; and
the first computing device, in communication with the server computer system, and configured to:
receive the first procurement document exchange certificate;
receive at least a portion of the second procurement document exchange certificate including a public key from the second computing device;
transmit at least a portion of the first procurement document exchange certificate to the second computing device for the second computing device to use to verify a signature of a later transmitted procurement document from the first computing device;
sign the procurement document; and
encrypt the signed procurement document using the public key for transmission directed to the second computing device.

2. The system of claim 1, further comprising:
the second computing device, in communication with the first computing device, and configured to:
generate a certificate signing request as a function of a private key;
transmit the certificate signing request to the server computer system; and
receive the second procurement document exchange certificate from the server computer system in response to the certificate signing request, the second procurement document exchange certificate generated at the server computer system using the certificate signing request.

3. The system of claim 2, wherein the second computing device is further configured to locally generate the private key.

4. The system of claim 2, wherein the second computing device is further configured to:
identify a public key in the received second procurement document exchange certificate; and
transmit the public key directed to the first computing device.

5. The system of claim 2, wherein the second computing device is further configured to:
receive the signed and encrypted procurement document; and
decrypt the signed and encrypted procurement document using the private key.

6. The system of claim 2, wherein the second computing device is further configured to:
verify the signature of the received procurement document using a received portion of the second procurement document exchange certificate from the first computing device.

7. The system of claim 1, further comprising:
the second computing device, in communication with the first computing device via a peer-to-peer communication link bypassing the server computer system, configured to receive the signed and encrypted procurement document from the first computing device via the peer-to-peer communication link.

8. The system of claim 1, further comprising:
a relay server, in communication with the first communication device, and configured to receive the signed and encrypted procurement document from the first computing device.

9. The system of claim 8, further comprising:
the second computing device, in communication with the relay server, and configured to receive the signed and encrypted procurement document from the relay server.

10. The system of claim 8, wherein the relay server comprises the server computer system.

11. A computer readable storage medium storing a computer program, the computer program comprising instructions executable by a computer to:
receive a first procurement document exchange certificate from a server computer system;
transmit at least a portion of the first procurement document exchange certificate directed to a computing device for use to verify a signature of a later transmitted procurement document;
receive at least a portion of a second procurement document exchange certificate including a public key from the computing device;
receive input to trigger a transmission of the procurement document to the computing device;
automatically sign, in response to the received input, the procurement document; and
automatically encrypt the signed procurement document using the public key in response to the received input, the encrypted procurement document for transmission directed to the computing device.

12. The computer readable storage medium of claim 11, the computer program further comprising instructions executable by the computer to:
generate a certificate signing request as a function of a private key; and
transmit the certificate signing request to the server computer system, wherein the first procurement document exchange certificate is generated in response to the certificate signing request and as a function of the certificate signing request.

13. The computer readable storage medium of claim 12, the computer program further comprising instructions executable by the computer to:
decrypt, using the private key, a second procurement document received from the computing device, wherein the at least a portion of the first procurement document exchange certificate includes a second public key used by the computing device to encrypt the second procurement document.

14. The computer readable storage medium of claim 11, wherein the instructions executable by the computer specify that the procurement document be signed using a portion of the first procurement document exchange certificate.

15. The computer readable storage medium of claim 11, wherein at least a portion of the second procurement document exchange certificate includes data to verify a signature of a second procurement document received from the computing device.

16. The computer readable storage medium of claim 11, where communication with the computing device is via a peer-to-peer communication link bypassing the server computer system.

17. A computer readable storage medium storing a computer program, the computer program comprising instructions executable by a computer to:
transmit a certificate request to a server computer system;
receive a first procurement document exchange certificate from the server computer system, the first procurement document exchange certificate generated at the server computer system using information in the request;
receive at least a portion of a second procurement document exchange certificate transmitted from a computing device;
transmit at least a portion of the first procurement document exchange certificate including a public key to the computing device;
receive a signed and encrypted procurement document, the signed and the encrypted procurement document encrypted by the computing device using the public key;
automatically decrypt the encrypted procurement document using the private key; and
automatically verify the signature of the decrypted procurement document using the received portion of the second procurement document exchange certificate.

18. The computer readable storage medium of claim 17, wherein the request comprises a certificate signing request.

19. The computer readable storage medium of claim 18, the computer program further comprising instructions executable by the computer to:
generate the certificate signing request as a function of a private key.

20. The computer readable storage medium of claim 19, the computer program further comprising instructions executable by the computer to:
generate the private key.

21. The computer readable storage medium of claim 17, the computer program further comprising instructions executable by the computer to:
encrypt a second procurement document for transmission to the computing device using a second public key, wherein the second procurement document exchange certificate includes the second public key generated at the computing device.

22. The computer readable storage medium of claim 17, the computer program further comprising instructions executable by the computer to:
sign, using at least a portion of the first procurement document exchange certificate, a second procurement document for transmission to the computing device.

23. The computer readable storage medium of claim 17, where communication with the computing device is via a peer-to-peer communication link bypassing the server computer system.

24. A system for an exchange of procurement documents, the system comprising:
a first computing device configured to:
transmit at least a portion of the first procurement document exchange certificate received from a server computer system;
receive at least a portion of a second procurement document exchange certificate including a public key from a second computing device;
sign a procurement document;
encrypt the signed procurement document using the public key in response to the received input; and
transmit the encrypted procurement document directed to the second computing device; and
the second computing device, in communication with the first communication device, and configured to:
receive the second procurement document exchange certificate from the server computer system, the second procurement document exchange certificate associated with a private key;
receive the at least a portion of the first procurement document exchange certificate transmitted from the first computing device;
transmit the at least a portion of the second procurement document exchange certificate including the public key to the first computing device;
decrypt the encrypted procurement document received from the first computing device using the private key; and
verify the signature of the decrypted procurement document using the received portion of the first procurement document exchange certificate.
